(19) United States
(12) Patent Application Publication
(10) Pub. No.: US 2017/0118651 A1
(43) Pub. Date: Apr. 27, 2017

(54) Mobile Security System

(71) Applicants: Vincenzo Iozzo, Milan (IT); Giovanni Gola, Milan (IT)

(72) Inventors: Vincenzo Iozzo, Milan (IT); Giovanni Gola, Milan (IT)

(73) Assignee: IperLane, Inc., New York, NY (US)

(21) Appl. No.: 15/298,339

(22) Filed: Oct. 20, 2016

Related U.S. Application Data
(60) Provisional application No. 62/245,353, filed on Oct. 23, 2015.

(51) Int. Cl. H04W 12/08; H04L 29/06; H04W 12/02; G06F 21/62; H04W 72/04; H04W 4/02

(52) U.S. Cl. CPC H04W 12/08; H04W 72/0493; H04W 4/025; H04W 12/02; G06F 21/6254; H04L 63/1425; H04W 88/02

(57) ABSTRACT

In a method for controlling access by a mobile device to data, at least one parameter is associated with the mobile device is defined. At least one rule for allowing access to the data is defined. The rule is based on a value of the at least one parameter. The parameter is accessed from the mobile device when the mobile device requests access to the data. If the values of the parameters indicate that access to the data is allowable, then the mobile device access is granted to the data. Otherwise if the values of the parameters indicate that access to the data is not allowable, then the mobile device is denied access to the data.

### CROSS-REFERENCE TO RELATED APPLICATION(S)

This application claims the benefit of U.S. Provisional Patent Application Ser. No. 62/245,353, filed Oct. 23, 2015, the entirety of which is hereby incorporated herein by reference.

### BACKGROUND OF THE INVENTION

1. Field of the Invention

The present invention is in the technical field of Information Security. More particularly, the present invention is in the technical field of Mobile Security and Data Security.

2. Description of the Related Art

Conventional mobile security systems, such as MDM and EMM, are typically either inflexible or require a high degree of customization of the mobile device. It is difficult to apply rules on data being handled by a mobile application that does not require the customer to adapt or replace their software or infrastructure. Further, these solutions typically are not capable of adapting their functioning based on the behavior or mobility data of the owner of the device. The difficulties of employing these solutions are amplified in the case of small and medium sized companies that do not have dedicated development teams and tend to use common off the shelf applications. Further, it is not uncommon these solutions to be disabled when employees or users find themselves in uncommon circumstances, such as while traveling or during client meetings. Further, the solutions have no knowledge of the user and their behavior, and hence they cannot prevent unauthorized third-party access to data in a timely manner, such as in the instance of a third party obtaining temporary access via a stolen device.

Therefore, there is a need for a system that detects unauthorized use of a mobile device in making data access decisions.

### SUMMARY OF THE INVENTION

The disadvantages of the prior art are overcome by the present invention which, in one aspect, is a method for controlling access by a mobile device to data, in which at least one parameter associated with the mobile device is defined. At least one rule for allowing access to the data is defined. The rule is based on a value of the at least one parameter. The parameter is accessed from the mobile device when the mobile device requests access to the data. If the values of the parameters indicate that access to the data is allowable, then the mobile device access is granted to the data. Otherwise if the values of the parameters indicate that access to the data is not allowable, then the mobile device is denied access to the data.

In another aspect, the invention is a method for controlling mobile device access to data, in which at least one parameter associated with the mobile device is defined. At least one rule for allowing access to the data is defined. The rule is based on a value of the at least one parameter by sensing values of the parameter associated with the mobile device over a period of time and defining the rule so that access is denied if current values of the parameter are inconsistent with the values of the parameter sensed over the period of time. The parameters are accessed from the mobile device when the mobile device requests access to the data. If the values of the parameters indicate that access to the data is allowable, then the mobile device is granted access to the data. Otherwise if the values of the parameters indicate that access to the data is not allowable, then the mobile device is denied access to the data.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic view, showing an arrangement of components in one embodiment of the present invention

FIG. 2 is a schematic view showing interaction between mobile devices and a server.

FIG. 3 is a schematic view of the rule creation console, showing how rules are written and how they are saved on the remote server.

FIG. 4 is a flow chart showing a method employed in one embodiment of the invention.

FIG. 5 is an example of a raw DSL language for rules writing, showing how rules can be written manually by an administration or an individual with similar skillset.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet. Also as used herein “short-range wireless interconnection devices” includes devices that comply with the Bluetooth standard.

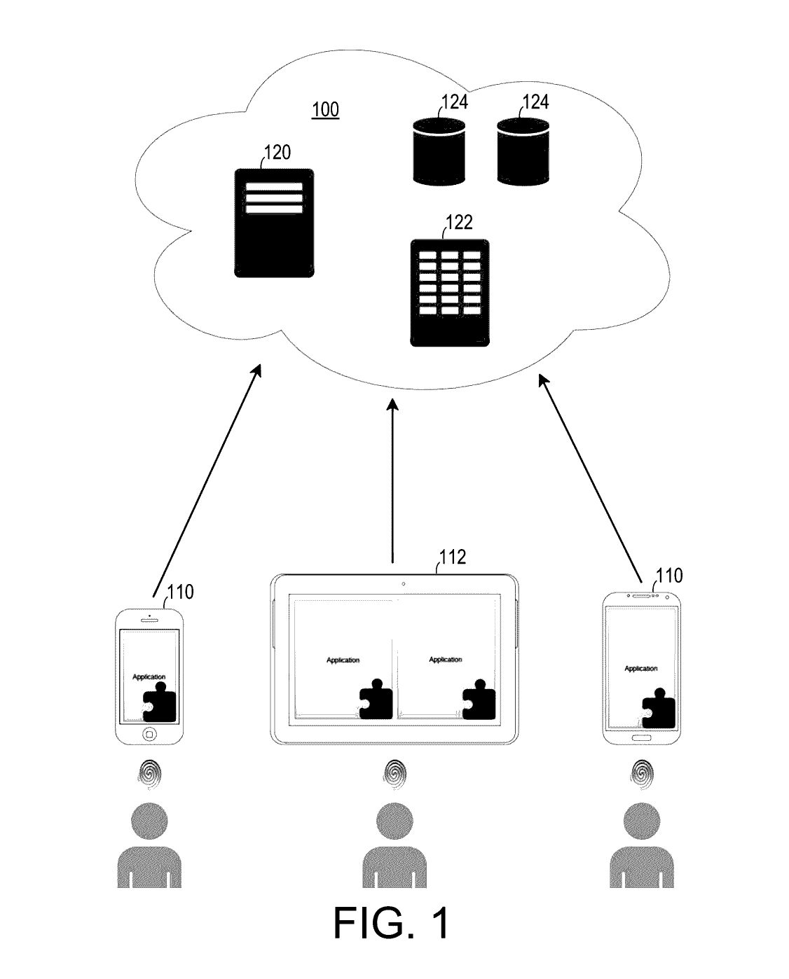

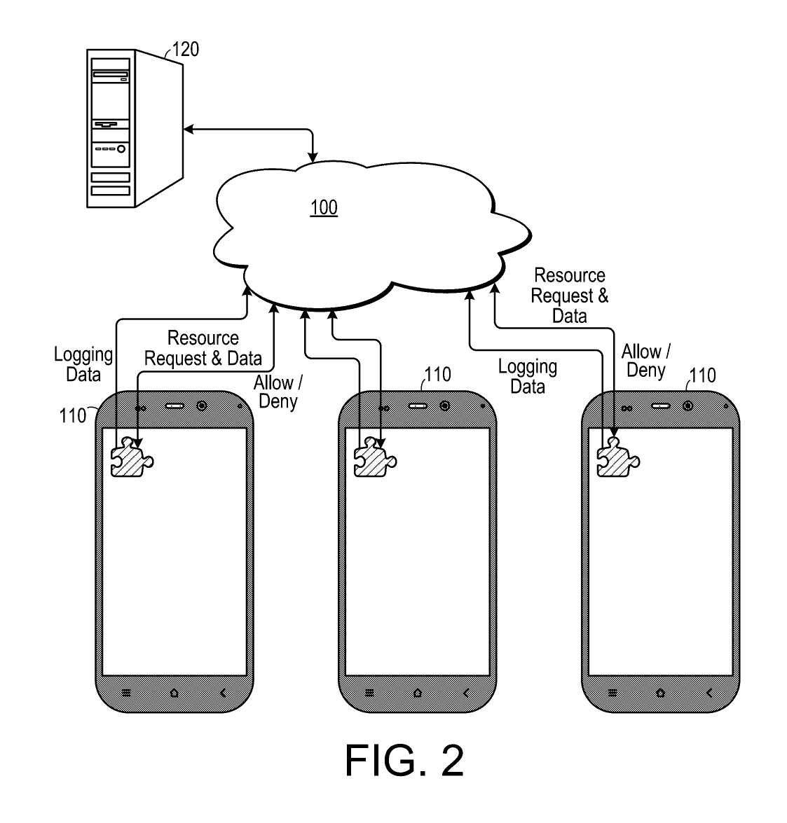

As shown in FIG. 1, one embodiment of the invention controls access between cloud-based devices (such as a remote server 120, processors 122 and storage media 124) and mobile devices (such as smart phones 110 and tablet devices 112) used by a user via a global computer network infrastructure. As shown in FIG. 2, the remote server 120 performs two tasks. The first task is to receive data from the mobile device and answer with an access granted or denied reply based on a decision system that processes incoming data. Consequently, a judgment is formulated on whether or not the user should be granted permission to access certain resources on the device or on a remote server. The second task is to receive logging information from the device, such as, but not limited to, number of attempts to access a certain results, failed attempts to read, write or delete a certain resource and general device integrity information as calculated by the software algorithms installed on the device. The remote server 120 is shown as fulfilling both tasks, but the tasks can be accomplished by a different infrastructure such as one server performing task 1 and another server performing task 2.

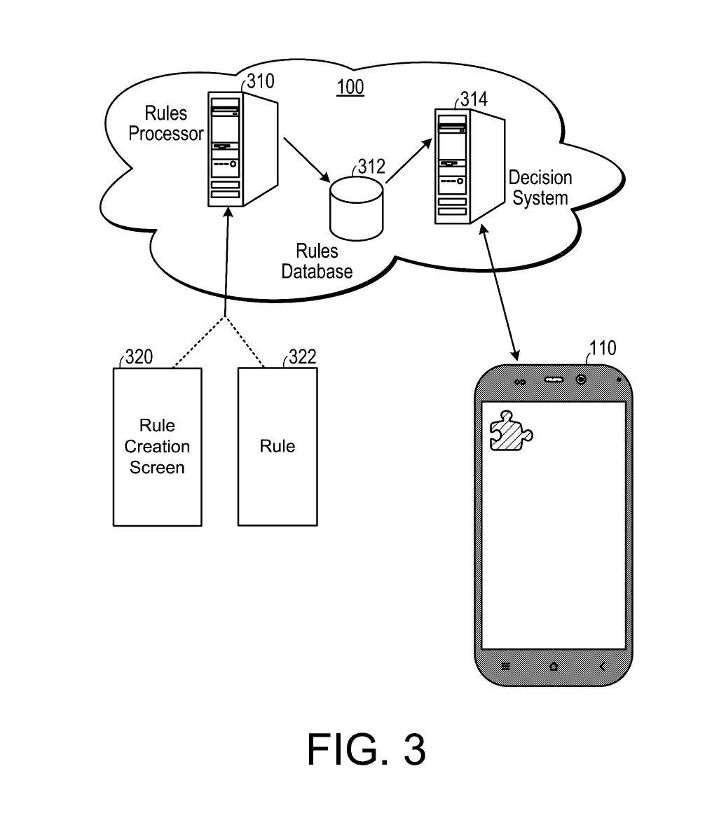

As shown in FIG. 3, the above-mentioned tasks can be divided among a rules processor 310 and a decision processor 314, both of which are in communication with a rules database 312. The rules processor 310 is in communication with a rule creation application 320, which generates a rule 322 (or a series of rules). Rules can be created, modified, deleted and updated using an ad-hoc DSL, a general purpose programming language or a user interface, including—but not limited to—web-based consoles. Rules are then transferred to the decision system and evaluated when a mobile device 110 tries to access a given resource that is either stored locally on the mobile device 110 or remotely on a server 312.

In one embodiment, the software used to effect operations in the system may include three or more components. One component is software that is used to collect data from the mobile device, such as GPS location, address book entries, accelerometer, gyroscope, Bluetooth devices, WiFi access points, keystrokes and other information. Part of the data is used by the second component of the software locally on the mobile device to drive the access control decisions. The other part of the data is transmitted to our server and used to drive more complicated policy decisions. Before the data is transmitted, a number of privacy and security precautions are taken, such as encryption, anonymization and others.

The second component of the software on the mobile device is responsible for hooking the runtime of the application using techniques such as dynamic binary re-writing, system calls interceptions and others. This component monitors the interaction of the application with the rest of the device as well as the access of the mobile application to sensitive data. Every time the application tries to access data, a component checks whether the rules allow such action and might or might not allow it. In addition to data access, the software can perform other security actions such as wiping the phone, enabling a remote server to locate the phone based on the phone location and other functions.

The last component of the software is responsible for logging the activity of the mobile device in relation to the rules and logging related information, such as attempts to read a file, open the address book, establish a connection and others. The log files can be either stored locally, or they can be sent to a remote server. All software components forming the system on the mobile device are packaged into a library, which is integrated into the mobile application prior to deployment.

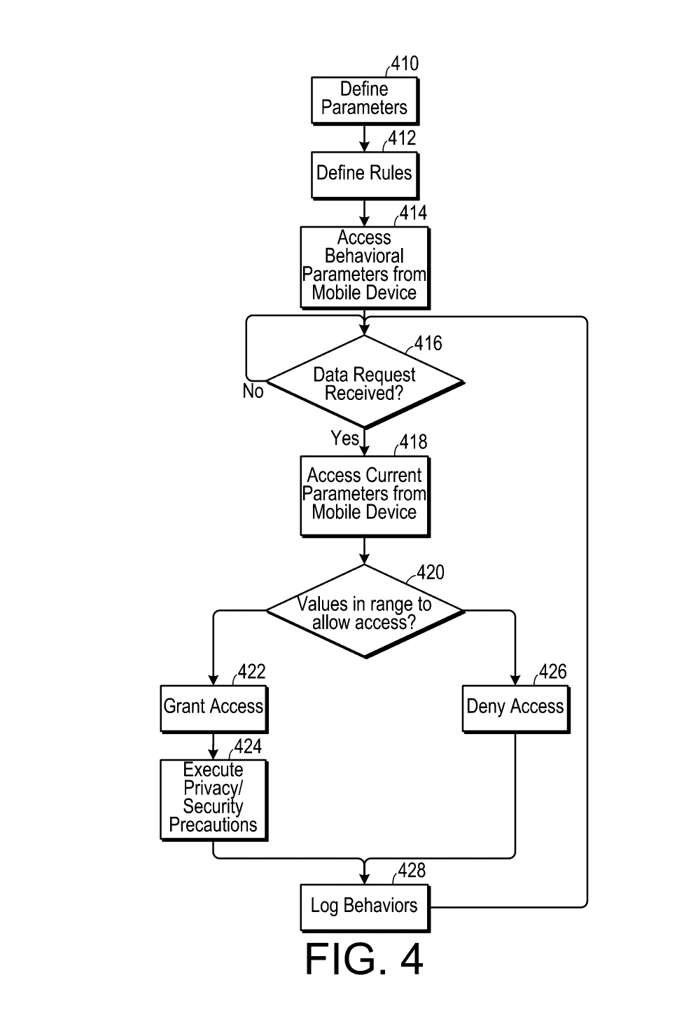

In one embodiment, as shown in FIG. 4, the administrator defines parameters 410 that are used in making data access decisions. For example, the speed a pattern of keystrokes on the mobile device could indicate whether the user of the mobile device is the authorized user or an unauthorized user. Other factors could include the location of the mobile device, movement patterns detected in the mobile device (which could be based on global positioning satellite (GPS) data, accelerometer data and gyroscope data), an indication of wireless devices (e.g., Bluetooth devices) communication with the mobile device and an identification of Wi-Fi access points to which the mobile device is connected. For example, rapid movements of a type characteristic of the movement of a mobile device thief could indicate that the device has been stolen can be detected by the system.

The administrator defines rules 412 based on the parameters and then the system can access the mobile device 414 to detect values of the parameters during periods of time in which a known authorized users is using the mobile device. These values can be stored and rules can use these values in making data access decisions.

When a request to access data is received 416 (either by the server or internally by the mobile device, or both), the system accesses the current values of the parameters from the mobile device 418. It the values are within a range 420 that is consistent with values that would give rise to a high confidence level, then the device is granted access to the data 422. The system could also execute privacy precautions (such as anonymizing the data) and security precautions (such as encrypting the data) 424. It the values not are within a range 420 that is consistent with values that would give rise to a high confidence level, then the mobile device is denied access to the data 426. The system can also log behaviors 428 associated with the mobile device. Such behaviors could include attempts to access data and attempts to access the mobile device's address book.

In one embodiment, an application runs on the mobile device that makes initial access control decisions and a remote server makes policy decisions regarding access to the data. In one embodiment, if unauthorized use is detected, the system can delete data from the mobile device and can even permanently delete (or “wipe”) the data from the mobile device's storage medium. In one embodiment, the system can also enable the remote server to locate the mobile device when an unauthorized use is detected.

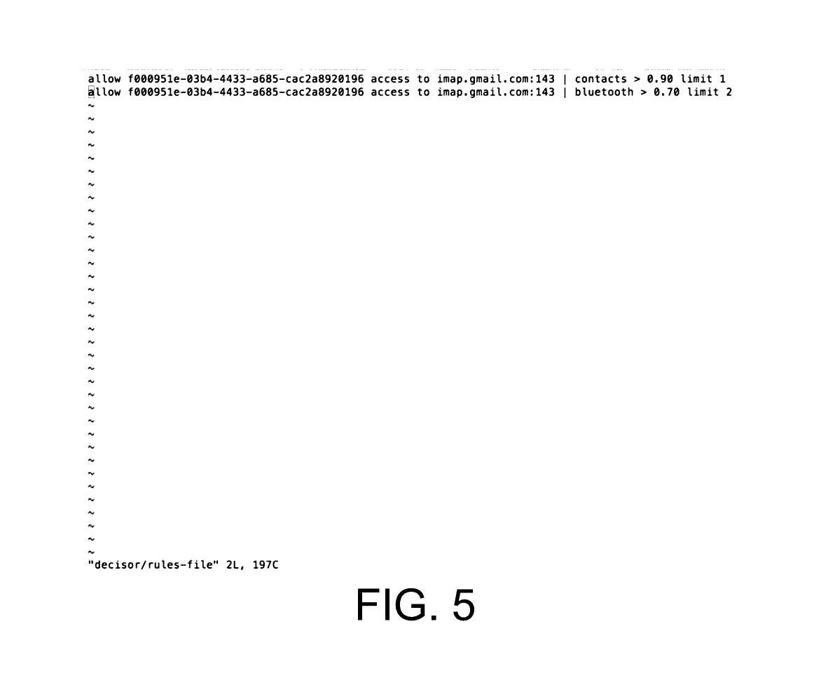

One example of a rule an administrator could write is shown in FIG. 5. As shown in the figure, a rule can restrict access to certain files, remote servers or other local data based on certain criteria, such as distance of a mobile phone from a given point of interest, integrity of the mobile device based on certain indicators, a confidence score that the phone is in the hands of its legitimate owner and others. The rules are either enforced by a component on the mobile device or on a remote server, depending on the type of data being accessed. Similarly, the criteria of the rules can either be processed locally or remotely, or both.

The computation of confidence intervals and scores on the ownership of the device, its integrity and various other predictive factors are computed by our algorithms.

In broad embodiment, the present invention is a language- and application-agnostic mobile security system that filters and controls the access to data stored on a mobile device as well as remotely stored data accessed through a mobile device at runtime in a dynamic way that is adjusted based on sensor data, user behavioral data and external data sources.

Three representative examples of application of one embodiment of application of the invention are presented below.

### Example 1

An administrator could write a comparison-based rule to compare the difference between the set of previous known data, such as Bluetooth-connected devices, and the latest set of collected data. When enforced, this can restrict devices other than the authorized user's device from accessing corporate assets. An administrator could want this sort of control to protect against instances of account takeover, in which the authorized user's credentials are stolen and attempted to be used by an unauthorized party on a different device.

### Example 2

An administrator could write an inclusion-based rule, such as whether a Wi-Fi access point or Bluetooth device is in range or not. When enforced, this can restrict access to corporate assets unless a specified signal or item is present. This includes requiring a Bluetooth device as a form of token, or requiring proximity to an office and its associated Wi-Fi access point to gain access. An administrator could want this sort of control to protect against instances of account takeover, a stolen device or ill-intentioned but authorized users, such as those seeking to share information with competitors.

### Example 3

An administrator could write pattern-based rule on the behavioral patterns of the authorized user. Examples of these patterns include GPS-based trajectories of a given user's travel patterns and the speed of a given user's keystrokes, both compared with those of the usual, authorized user's behaviors. An administrator could want this sort of control to protect broadly against unauthorized users by detecting anomalous user behavior, such as in instances of a stolen device or account takeover.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for controlling access by a mobile device to data, comprising the steps of:
(a) defining at least one parameter associated with the mobile device;
(b) defining at least one rule for allowing access to the data, wherein the rule is based on a value of the at least one parameter;
(c) accessing the parameter from the mobile device when the mobile device requests access to the data; and
(d) if the values of the parameters indicate that access to the data is allowable, then granting the mobile device access to the data, otherwise if the values of the parameters indicate that access to the data is not allowable, then denying the mobile device access to the data.

2. The method of claim 1, wherein the step of defining values of the parameters comprises the steps of:
(a) sensing values of the parameter associated with the mobile device over a period of time; and
(b) defining the rule so that access is denied if current values of the parameter are inconsistent with the values of the parameter sensed over the period of time.

3. The method of claim 2, wherein the at least one parameter is selected from a list of parameters consisting of: GPS location of the mobile device, address book entries stored by the mobile device, accelerometer data stored on the mobile device, gyroscope data stored on the mobile device, identification of at least one short-range wireless interconnection device connected to the mobile device, identification of WiFi access points with which the mobile device is communicating, physical characteristics of keystrokes entered on the mobile device.

4. The method of claim 1, wherein an application runs on the mobile device that makes initial access control decisions and wherein a remote server makes policy decisions regarding access to the data.

5. The method of claim 1, further comprising the step of deleting data from the mobile device when value of the at least one parameter is consistent with a value expected when an unauthorized user is using the mobile device.

6. The method of claim 1, further comprising the step of enabling a remote server to locate the mobile device when value of the at least one parameter is consistent with a value expected when an unauthorized user is using the mobile device.

7. The method of claim 1, further comprising the step of logging activity of the mobile device in regard to conformance of the mobile device with the rule.

8. The method of claim 7, wherein the logging step comprises the step of logging attempts to read a file.

9. The method of claim 7, wherein the logging step comprises the step of logging attempts to open an address book.

10. A method for controlling mobile device access to data, comprising the steps of:
(a) defining at least one parameter associated with the mobile device;
(b) defining at least one rule for allowing access to the data, wherein the rule is based on a value of the at least one parameter by sensing values of the parameter associated with the mobile device over a period of time and defining the rule so that access is denied if current values of the parameter are inconsistent with the values of the parameter sensed over the period of time;
(c) accessing the parameters from the mobile device when the mobile device requests access to the data; and
(d) if the values of the parameters indicate that access to the data is allowable, then granting the mobile device access to the data, otherwise if the values of the parameters indicate that access to the data is not allowable, then denying the mobile device access to the data.

11. The method of claim 10, wherein the at least one parameter is selected from a list of parameters consisting of: GPS location of the mobile device, address book entries stored by the mobile device, accelerometer data stored on the mobile device, gyroscope data stored on the mobile device, identification of at least one short-range wireless interconnection device connected to the mobile device, identification of WiFi access points with which the mobile device is communicating, physical characteristics of keystrokes entered on the mobile device.

12. The method of claim 10, further comprising the step of taking at least one of a privacy precaution or a security precaution prior to the step of granting the mobile device access to the data, wherein at least one of a privacy precaution comprises anonymizing the data and wherein the security precaution comprises encrypting the data.

13. The method of claim 10, wherein an application runs on the mobile device that makes initial access control decisions and wherein a remote server makes policy decisions regarding access to the data.

14. The method of claim 10, further comprising the step of deleting data from the mobile device when value of the at least one parameter is consistent with a value expected when an unauthorized user is using the mobile device.

15. The method of claim 10, further comprising the step of enabling a remote server to locate the mobile device when value of the at least one parameter is consistent with a value expected when an unauthorized user is using the mobile device.

16. The method of claim 10, further comprising the step of logging attempts to read a file and the step of logging attempts to open an address book.
